(19) United States
(12) Patent Application Publication
(10) Pub. No.: US 2018/0065851 A1
(43) Pub. Date: Mar. 8, 2018

(54) SETR- SUPER ENHANCED TAIL GAS RECOVERY; A TAIL GAS PROCESS WITH ADSORBENT REACTORS FOR ZERO EMISSIONS

(71) Applicants: Mahin Rameshni, Monrovia, CA (US); Stephen L. Santo, La Crescenta, CA (US)

(72) Inventors: Mahin Rameshni, Monrovia, CA (US); Stephen L. Santo, La Crescenta, CA (US)

(21) Appl. No.: 15/256,539

(22) Filed: Sep. 3, 2016

(51) Int. Cl. C01B 17/04; B01D 53/04; B01D 53/86; B01D 53/75

(52) U.S. Cl. CPC C01B 17/0456; B01D 53/0462; B01D 53/8609; B01D 53/75; B01D 2253/1122; B01D 2255/20707; B01D 2255/2092; B01D 2259/40003; B01D 2257/302; B01D 2255/40

(57) ABSTRACT

SETR tail gas treating process refers to an innovative process consist of the adsorbent and regeneration reactors. The SETR reactor stands for Super Enhanced Tail gas Recovery switching between adsorption and regeneration mode and the STER reactors are located after the tail gas incineration before the stack replacing any type of the caustic scrubber system. The SETR innovative process is not a sub dew point process where the bed become saturated with sulfur, instead, the SETR process are fixed bed reactors that requires heat up and cool down for the SO2 adsorption-based Claus tail gas process. The adsorption mode operates at cold temperature to adsorb the SO2. The regenerator mode operates at hot temperature to regenerate the SO2 by adding a slip stream of the H2S and air from the SRU to the SETR reactor that contains adsorbed SO2 to promote the Claus reaction. In the SETR reactors H2S to react with the adsorbed SO2 in the bed with oxygen the outlet of the hot reactor is recycled to the SRU thermal or catalytic section. The gas stream from the adsorbed cold reactor flows to the stack and it is SO2 free and zero emission is achieved.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### REFERENCE TO A TABLE

Not Applicable

### REFERENCE TO A COMPUTER PROGRAM LISTING COMPACT DISK APPENDIX

Not Applicable

### BACKGROUND OF THE INVENTION

This disclosure relates generally to Process the tail stream from the sulfur recovery unit through ADSORBENT/REGENERATOR SO2 REACTORS using switching valves. The SETR reactor stands for Super Enhanced Tail gas Recovery switching between adsorption and regeneration mode and the STER REACTORS are located after the tail gas incineration before the stack replacing of any the caustic scrubber system. The adsorption mode operates at cold temperature to adsorb the SO2. The regenerator reactor operates at hot temperature to regenerate the SO2 by adding a slip stream of the H2S acid gas stream and a slip stream of the air from the SRU air blower to the top of the SETR reactor that contains adsorbed SO2. The SETR reactors consist of alumina and titanium catalysts; H2S to react with the adsorbed SO2 in the bed with oxygen present and the gas stream leaving the regenerator or hot reactor is then recycled to the sulfur recovery unit to the reaction furnace or downstream of the Claus thermal section. The gas stream from the adsorbed cold reactor flows to the stack and it is SO2 free and zero emission is achieved.

### DESCRIPTION OF THE RELATED ART

The most commonly used process for recovering elemental sulfur from sulfur compounds is the modified Claus process. The modified Claus process can achieve the sulfur recovery of ranging 93-97% depends of the acid gas feed compositions. The tail gas stream from the Claus unit has to be further processed in one of the common tail as unit technology; tail gas hydrogenation process followed by the amine tail gas to recover the remaining sulfur compounds by achieving about 99.9% recovery meaning the stack may still contains up to 250 ppmv of SO2. The treated gas from the tail gas absorber flows to the incineration system where the stack has to meet the required emission of SO2 less than 250 ppmv and even in some locations less than 50 ppmv of SO2. In United States and many other countries if the tail gas unit is down the Claus unit has to be shut down due to low sulfur recovery and violation of the emission and they are required to have a backup tail gas unit for such cases.

Sulfur plant operation is a very complicated and challenging job. Acid gas feed to a sulfur plant usually includes wide variation in the volume and concentration of sulfur and other compounds, including a substantial amount of ammonia or amine acid gases in some plants. Theoretically, control of the thermal stage(s) using air, enriched air or oxygen for conversion of H2S to SO2 has permitted some processes to obtain extremely high recovery of sulfur whether for the 2:1 ratio for H2S to SO2 or for H2S-shifted operation. In actual operation, the several interactions of stream component analysis and measurement of flow, temperature, pressure and other process parameters with the compressors, valves, burners, aging or fouled catalyst beds and other process equipment has made error-free, continuous recovery of sulfur from acid gas an elusive goal.

The SETR reactors refer to a special innovative reactor design configuration where each reactor operates as SO2 adsorbent cold mode and as SO2 Regenerator hot mode; switching mode of operation takes place by using the switching valves.

The SETR innovative process is not a sub dew point process where the bed become saturated with sulfur, instead, the SETR process are fixed bed reactors that requires heat up and cool down for the SO2 adsorption-based Claus tail gas process. The SETR reactors are located after the incineration system before the stack replacing any type of the caustic scrubber system.

After the Claus process with 2 or 3 Claus stage; it is required to have a tail gas treating system to process the remaining H2S and SO2 from the Claus unit. The innovative tail gas treating system is the SETR reactors which, consists of two modes of operations.

In the adsorption mode the cooled stream from the incineration flows to the reactor where SO2 is absorbed. In the regeneration hot mode a slip stream of the acid gas feed to the Claus and a slip stream of air from the combustion air blower flows to the regenerator reactor to regenerate the SO2; where due to oxygen presence the adequate heat is generated inside of the reactor. The chemical reaction take place according to the Claus reaction, and H2S, SO2 and sulfur are the minimum components that are recycled back to the thermal or catalytic stage of the Claus unit.

The SETR reactors also contain Claus catalyst; alumina, Titanium or any combination of suitable Claus catalysts. The Claus unit contains alumina, Titanium, direct oxidation, direct reduction and any combination of suitable Claus catalysts.

In accordance with the current innovation, the gas leaving the adsorbent cold reactor; it is SO2 free and flows to the stack and the gas leaving the regenerator reactor consisting of H2S, SO2 and sulfur as a minimum where it is recycled back to the Claus unit, the air from the combustion air blower and amine acid gas both have the adequate pressure to force the recycle back to the Claus unit.

In accordance with the current innovation, since the SETR reactors are located after the incineration, all the sulfur compounds are already is converted to SO2 and the Claus unit operates at 2:1 ratio of H2S/SO2.

In accordance with the current innovation, the SETR adsorption reactor operates at 125 C to 130 C to maximize the SO2 adsorption and the SETR regeneration reactor operates at 320 C to 400 C to maximize the SO2 regeneration with Claus reaction.

Since the adsorbent must be able to tolerate oxygen from the air stream, and must also have capability to catalyze the Claus reaction in the regeneration step, Titanium catalyst is located at top layer of the SETR reactors. The lab data shows that Titanium catalyst exhibits stable and reproducible SO2 adsorption. The regeneration procedure accomplishes a number of chemical transformations, most importantly, SO2 is recovered very fast where the H2S stream was present. The reaction of H2S, air and SO2 will results sulfur where the outlet stream is recycled to the Claus unit to recover the produced sulfur.

It is noted that the regenerated stream will be enriched in SO2, if plant operates at H2S/SO2 ratio larger than 2, one advantage of this innovation is that advanced ratio control is not necessary as the SO2 adsorption steps acts to mitigate any variations in ratio. In practice, the plant will be controlled by ratio measurement and control on the tail gas process stream with the value set at 2:1 to optimize conversion of the sulfur in the Claus reactor.

In this innovative; the sulfur recovery unit with the SETR reactors can meet minimum of 99.99%+sulfur recovery; the emission of less than 10 ppmv of SO2 can be achieved which is near 100% sulfur recovery.

The present innovation is SO2 adsorption/regeneration using the SETR reactors by recovering SO2 and making sulfur and recycling it back to the Claus unit, meaning there is no sulfur components are wasted but everything is recovered to its maximum level.

In accordance with aspects of the present invention, the SETR system will be two reactors consists of the combination of the Claus catalysts and the switching valves for changing the mode of operation hot or cold. These valves are located on the inlet and outlet streams of these reactors.

The present the SETR tail gas unit innovation can be added after the incineration to increase the recovery even the tail gas treating may already be present like to Beavon Tail gas Treating, SCOTT type tail gas treating unit, Cansolv type tail gas treating, and to eliminate any type of the caustic scrubber system like DYNAWAVE or similar. The SETR reactors can be added to any sub dew point tail gas processes like Smartsulf, SuperSulf, MCRC CBA, and Sulfreen or similar and can be added to SuperClaus, EuroClaus, SMAX, and SMAXB or similar while it meets the zero emission near 100% sulfur conversion.

There are many existing sulfur recovery and tail gas treating in operation worldwide that do not meet the new regulations. The common solution has been to add any type of the caustic scrubber system after the incineration to capture the SO2 before is routed to the atmosphere.

The disadvantage of the caustic scrubber is new waste stream so called spent caustic. The spent caustic is the waste stream needs to be disposed safely or neutralized where in some facilities dealing with the spent caustic is major issues. The innovative SETR reactors do not generate any waste. The SETR reactors can be added after the incineration instead of any type of the caustic scrubber system. The key advantage is the additional sulfur compounds are recovered and sent back to the sulfur plant. The SETR process is cost competitive solutions and do not need any chemicals, and not generate any waste stream and most importantly, the emission will be near zero without using any chemicals or solvents.

The switching valves for the SETR process are 2-way or 3-way motor valves where they operate automatically switching between two reactors for cold and hot operation.

The capital cost of the building tail gas unit is very close to the cost of building a modified conventional Claus unit considering for using it to recover only the remaining sulfur compounds which, were not recovered in the Claus unit, the fact is that it is not cost effective. In present innovative the SETR process as the tail gas unit is much smaller due to less equipment and resulting lower capital cost, lower maintenance, smaller plot space, and easy to operate.

The present invention could be used for the existing Claus units by making the required modifications after the incineration, and for new sulfur recovery units to achieve much higher sulfur recovery up to 100% or basically zero emission with less capital costs.

The new SETR innovative reactors are not a sub dew point Process it consists of 2 reactors that each reactor operates as adsorption and regeneration where switching reactors are performed using switching valves automatically in the control room the switching times are defined case by case depending on the SO2 concentration from incineration that results within 24 hours.

The pit vent from the sulfur pit is routed to the incineration traditionally and recently is routed to the Claus unit to reduce the stack emission. Using the innovative SETR process, the pit vent can route either location because ultimately it is burned in the incineration and among other stream is recycled back to the Claus unit, so it is less expensive to send the pit vent to the incineration and still meet the emissions.

The SETR innovative process is not a sub dew point process where the bed become saturated with sulfur and involved with heating up and cooling down, instead, the SETR process are fixed bed reactors that requires heat up and cool down for the SO2 adsorption-based Claus tail gas process.

In patent application, (U.S. Pat. No. 4,482,532, dated Nov. 13, 1984, Standard Oil Company), (U.S. Pat. Nos. 5,015,459, 5,015,460 dated May 14, 1991, 4,601,330 dated May 20, 1985, by Amoco) and (U.S. Pat. No. 8,815,203 dated Apr. 17, 2013, J. Lamar) describes a process of Sub Dew Point process known as Cold Bed Adsorption (CBA) acts as the tail gas unit where the main difference are these reactors operate as sub dew point process and no stream gas from these reactors are recycled to the Claus unit. In accordance to this innovation, SETR reactors do not operate as sub dew point process but operates as the adsorption process in addition the regenerated gas stream is recycled back to the Claus unit which the sulfur recovery is much higher compare to any sub dew point alone.

In patent application, European patents, (EP-983252, dated May 7, 1997),(EP-2594328, dated Nov. 21, 2011), (EP-1621250, dated Jul. 29, 2004), (EP-963247 DE-19754185, dated Dec. 6, 1997, (EP-1002571, dated Nov. 6, 1998) by Dr. Michael Heisel through Linde, DEG Engineering and ITS engineering and (EP-14307188, dated Dec. 24, 2014) by Prosernat; where known as Smartsulf reactors. In this process there are 2 identical reactors equipped with internal cooling as the tail gas section; to produce the sulfur and to regenerate the sulfur as the sub dew point process; while the present innovation SETR reactors do not have any internal cooling, do not operate as the sub dew point process, SETR operates as the adsorption process and the regenerated gas stream is recycled back to the process SO2 is adsorbed and regenerated in addition the regenerated stream is recycled back to the Claus unit to achieve much higher sulfur recovery.

In the patented process, May 5, 2015 (U.S. Pat. No. 9,023,309 B1) by M. Rameshni; known as SMAX AND SMAXB the zero emission is achieved by using any type of the caustic scrubber system after the incineration where disposal of the waste caustic and using chemical are disadvantages of this process, the caustic scrubber system can be replaced by SETR reactors without generating any waste, without using any chemicals and the actual sulfur is recovered by the recycling of the regeneration back to the Claus unit.

The new innovation SETR reactor is a main key differentiator as SO2 adsorber and regenerator where the regenerator SETR REACTOR outlet is recycled to the Claus unit compare to CBA, MCRC, Smartsulf, SuperSulf, Sulfreen or any commercial Sub Dew Point processes and even processes like SuperClaus, EuroClaus, SMAX, SMAXB where there is no recycle to the Claus unit but their goal is to produce sulfur in the reactor bed which it will achieve less than 99.9% recovery and in compare to BSR, SCOTT, RICH-SMAX, ARCO, or any commercial tail gas treating system where the zero emission is not possible unless adding one of the caustic scrubber system after the incineration to all above processes. While in the SETR process is the unique adsorbent tail gas unit where the caustic scrubber would not be required and in fact the remaining un-recovered sulfur components from the SETR process are recycled back and it is in fact recovered.

The main difference between the caustic scrubber system and The SETR process is that using caustic scrubber requires using chemical as caustic on regular basis, caustic absorbs the remaining of sulfur compounds in form of SO2 and produce spent caustic where the unrecovered sulfur compounds is wasted, in addition, it requires disposal of the spent caustic or neutralization; however, the new SETR reactors do not require any chemicals, do not generate any chemical waste and unrecovered sulfur compounds are separated and recycled back to the Claus for further recovery and finally environmentally acceptable.

In accordance with the new discloses process; the innovation SETR reactors represent the adsorption of sulfur compounds in a cold bed and then the regeneration of the sulfur compounds in a hot bed by using air and acid gas stream at the adequate temperature to have the Claus reaction taking place for additional sulfur recovery that would be wasted otherwise.

In accordance with the present invention, the air stream is taken from the main combustion air blower and the acid gas stream is taken from the main amine acid gas feed stream where both streams have adequate pressure and driving force to push the recycle back to the Claus unit. The main purpose of adding the H2S stream to promote faster regeneration and the main reason of adding air stream to establish the Claus reaction and to generate the adequate temperature.

### BRIEF SUMMARY OF THE INVENTION

The present invention relates to a process for recovering unconverted sulfur compounds mostly in the form of SO2 in 2 switching SETR reactor beds. SO2 is adsorbed in a cold bed SETR reactor as the results the gas leaving the cold reactor to the stack is SO2 free. The cold bed SETR reactor containing adsorbed SO2 then switches to a hot bed SETR reactor to regenerate the adsorbed sulfur compounds by using an slip air stream and the slip acid gas stream to establish the adequate temperature to regenerate the adsorbed sulfur compounds and the gas stream leaving the hot reactor is recycled to the thermal or catalytic section of the Claus unit.

The tail gas stream from the Claus unit at least containing H2S, SO2, COS, CS2, CO2, H2O and sulfur derived from the second or third stage Claus unit that is equipped with thermal stage or direct oxidation catalytic stage.

The SETR reactors consist of hot and cold reactors equipped with 2 or 3 way motor switching valves. The acid gas stream to the cold SETR reactor is driven from the incinerator waste heat boiler where all the sulfur compounds are converted to SO2.

The SETR hot reactor receives a slip stream of the feed amine acid gas containing H2S to the Claus plus slip stream of air from the main combustion air blower. The regenerated stream from the hot SETR reactor is recycled back to the thermal or catalytic section of the Claus unit.

The new innovative scheme will minimize the SO2 emission to stack in a very cost effective scheme. The switching valves are located on (1) the acid gas stream from the incineration waste boiler or a cooler containing SO2, (2) on the slip stream of the feed amine acid gas containing H2S, (3) on the slip air stream, (4) on the cold reactor outlet to the stack, and finally (5) on the hot reactor outlet that is recycled back to the Claus unit.

The Claus and SETR reactors consist of alumina, Titanium catalysts but no limited to mixture of CO, MO, Fe, Zn, Mg, Ni, Mo, Mn, Cr and Al, for conversion of SO2 to H2S, without any limitation using mentioned catalyst to increase selectivity that are to enhance of much higher recovery compare to the conventional Claus and tail gas units.

In accordance with aspects of the present invention, the process comprises a thermal stage for an H2S-rich acid gas feed or catalytic stage (such as a direct oxidation Selectox catalyst stage) for an H2S-lean acid gas feed where H2S is oxidized at least in part to SO2 or where a process gas is obtained with a reactionable amount of SO2 in the presence of a significant amount of H2S.

The acid gases are processed in the thermal section are the amine acid gas and the sour water stripper gases containing but not limited to H2S, NH3, HCN, H2, CO, CO2, O2 COS, N2, CS2, hydrocarbons, mercaptans, sulfur vapors and steam water.

The thermal section consists of the reaction furnace and acid gas burner operates with air, enriched air with oxygen up to 100% oxygen as combustion agent. For low H2S concentration natural gas supplement is added to boost the combustion temperature.

In accordance with the present invention, the reaction furnace consists of at least one refractory vessel for air operation and more than one refractory vessel for oxygen enrichment operation to control the combustion temperature. Each vessel consists of minimum one or two zones.

In the thermal stage, reducing gases such as H2 and CO are formed via dissociation reactions under overall sub-stoichiometric combustion; in the thermal stage and the Claus stage(s), elemental sulfur is produced according to the Claus reaction.

In accordance with first aspects of the present invention, the Claus process comprises one or more catalytic stages in which consists of alumina and Titanium catalysts and no limited to mixture of CO, MO, Fe, Zn, Mg, Ni, Mo, Mn, Cr and Al which to perform Claus reaction and to hydrolyze COS, CS2 and other sulfur compounds by products from the thermal stage to H2S according to the Claus reaction of (2 H2S+SO2->2 H2O+3/n Sn) produces elemental sulfur;

In accordance with second aspects of the present invention, the Tail gas stream from the Claus section is further processed. The tail stream is sent to the incineration system to convert all of sulfur compounds to SO2. The combusted gas is cooled and is sent to the new innovation process that comprises two subsequent catalytic stages in the SETR innovative reactors configuration equipped with switching valves, and any other vent gas from incineration is also burned and routed to SETR reactors;

In accordance with third aspects of the present invention, the SETR reactor consists of adsorption mode and regeneration mode of operation. In the adsorption mode the reactor shall be cold 125 C to 130 C to maximize the SO2 adsorption, and in the regeneration the reactor shall be hot at 320 C to 400 C to maximize the SO2 regeneration;

In accordance with forth aspects of the present invention the vent gas from the cold reactor is free SO2 and flows to the stack and the vent from the hot reactor flows back as the recycle to the thermal or catalytic stage of the Claus unit;

In accordance with fifth aspects of the present invention where the SETR reactors mode of operation is controlled by using the 2-way or 3-way switching valves. The switching valves are located on (1) the acid gas stream from the incineration waste boiler or the cooler, (2) on the slip stream of the feed amine acid gas, (3) on the slip air stream, (4) on the cold reactor outlet to stack, and finally (5) on the hot reactor outlet that is recycled back to the Claus unit;

In accordance with sixth aspects of the present invention, the vent gas from SETR hot reactor containing SO2, H2S, and sulfur where is recycled back to the Claus unit;

In accordance with seventh aspects of the SETR tail gas process; SETR reactors can be added after the incineration systems in the existing sulfur plants that consisting of the conventional tail gas treating unit like Beavon, ARCO or SCOTT, or any sub dew point processes like CBA, Smartsulf, MCRC, Sulfreen, and SuperSulf and the Claus units containing direct reduction and or direct oxidation like SuperClaus, EuroClaus, SMAX and SMAXB in order to reduce the emission and to meet the new environmental regulations and to achieve near 100% recovery;

In accordance with eighth aspects of the present invention, if there is any type of the caustic scrubber after the incineration, it can be eliminated and is replaced by SETR reactors;

In accordance with ninth aspects of the present invention, the SETR adsorption reactor operates at 125 C to 130 C to maximize the SO2 adsorption and the SETR regeneration reactor operates at 320 C to 400 C to maximize the SO2 regeneration with Claus reaction.

In one preferred embodiment, in the Claus section, H2S (hydrogen sulfide) in the acid gas feed is partially oxidized with oxygen in a thermal stage before further conversion in one or more Claus catalytic stages. The H2S:SO2 ratio in the gases reacted in the Claus stage is preferably at 2:1, although the process of the present invention may be practiced with off ratio without significantly affecting the overall sulfur recovery efficiency of the process.

In accordance with tenth aspects of the present invention the SETR process is added after incineration for applications dealing with the lean acid gas and low H2S concentration, it is not suitable to apply a thermal stage due to the difficulty in sustaining stable flames therein. In conjunction with a catalytic first stage using a direct oxidation catalyst such as Selectox or titanium; the present invention is also applicable to more completely recover elemental sulfur from lean streams, for both the non-recycle and recycle processes using Selectox or similar catalysts. The recycle process uses a cooled first stage effluent recycled to the inlet of the first stage to control temperature rise across the stage upstream of SETR reactor For acid gas streams with less than about 5 mole percent H2S, no recycle is generally needed.

In accordance with embodiment of the current innovative process the SETR reactors can be added to more complicated scheme such as Partial tail gas enrichment unit as known as RICH-SMAX or similar. The SETR reactors can also be added to more complex scheme where the sulfur recovery dealing with challenges of designing grass root SRU'S with a wide range of the H2S concentration. In this scheme the conventional reaction furnace is modified where a split stream of the amine acid gas flows to the tail gas absorber where the amine tail gas unit is designed as the Partial acid gas enrichment as known as RICH-SMAX process. The treated gas from the absorber overhead flows to the incineration and the combusted gas flows to the new innovative process SETR reactors. The regeneration overhead is recycled to the SRU but to the second zone of the reaction furnace through the repeater.

The new invention offers the following advantages:

(1) the SETR can be added after the incineration in any sulfur recovery process such as a conventional Claus, direct oxidation and reduction like SuperClaus, EuroClaus, SMAX, SMAXB or similar, any sub dew point process like CBA, Smartsulf, SuperSulf, MCRC, Sulfreen or similar, any conventional tail gas treating unit like BSR, ARCO, SCOTT and RICH-SMAX or similar, and after tail gas catalytic or thermal incineration.
(2) In the present innovation; the front-end section comprises a thermal stage or catalytic stage feeding its effluent to the Claus catalytic stages, the effluent preferably having an H2S:SO2 ratio of 2:1 for optimal sulfur recovery efficiency in accordance with the Claus reaction.
(3) The catalysts used are alumina, and Titanium, but not limited to CO, MO, Fe, Zn, Mg, Ni, Mo, Mn, Cr and Al, for conversion of Sulfur specious to H2S.
(4) Within the control fluctuations and deviations created under actual operating conditions of the modern sulfur plants, typical operation of the thermal stage in such sulfur plants with the modified Claus process produces more than the necessary stoichiometric amount of reducing gases.
(5) The SETR process consists of 2 adsorbent reactors operates in hot and cold mode of operation to adsorb sulfur compounds in the bed where the flue gas to stack is sulfur free and during the regeneration the adsorbed sulfur compounds are recovered and recycled to the Claus unit without using any chemical like solvent and without generating any waste stream like spent caustic. Basically no sulfur compounds are wasted and fully recovered and environmental friendly.
(6) The switching valves are automated for changing mode of operations of adsorption and regeneration and the cycle time are defined as a function of sulfur compounds has to be adsorbed.
(7) Finally it is the most cost effective option in regard to safety, ease of operation, create no waste, no chemical is used and achieve near 100% sulfur recovery.

Many plants must recover sulfur from lean sulfur streams (from trace amounts to 30 mole percent) for which it is not suitable to apply a thermal stage due to the difficulty in sustaining stable flames therein. In conjunction with a catalytic first stage using a direct oxidation catalyst such as Selectox or Titanium, the present invention is also applicable to more completely recover elemental sulfur from lean streams, for both the non-recycle and recycle processes using Selectox or similar catalysts. The recycle process uses a cooled first stage effluent recycled to the inlet of the first stage to control temperature rise across the stage upstream of Claus reactor For acid gas streams with less than about 5 mole percent H2S, no recycle is generally needed.

The innovative SETR reactors are horizontal or vertical depends on the size and normally made from high grade Carbon steel acid resistance with refractory or stainless steel.

### BRIEF DESCRIPTION OF THE DRAWINGS

The following figures are part of the present disclosure and are included to further illustrate certain aspects of the present invention. Aspects of the invention may be understood by reference to one or more figures in combination with the detailed written description of specific embodiments presented herein. FIG. 1c represents the innovative SETR process where it can be employed to variety type of Claus as several schemes as are discussed below.

FIG. 1 consists of drawings, 1-1a, 1-1b and 1-1c and illustrates a schematic diagram embodiment of the present disclosure consisting of (1a) Claus section which includes the thermal section and 2 OR 3 catalytic stages, (1b) the incineration system that receives the tail gas stream from the last condenser directly, (1c) the innovative SETR scheme that receives the gas stream from the incineration outlet.

FIG. 2 consists of 2-2a, 1-1b, and 1-1c where illustrates a schematic diagram of an alternate embodiment of the present disclosure consisting (1a) where the thermal section in FIG. 1-1a can be replaced with a direct oxidation catalytic stage for lean gas application. Upon the emission requirements SETR is added to improve the sulfur recovery as necessary stage followed by 2 or 3 Claus stages, (1b) illustrates the incineration system that receives the tail gas stream from the last condenser directly, (1c) the innovative SETR scheme that receives the gas stream from the incineration outlet.

FIG. 3 consists of 3-3a, 1-1b, and 1-1c, where illustrates diagram of an alternate embodiment of the present disclosure illustrates the scheme from the patented process, May 5, 2015 (U.S. Pat. No. 9,023,309 B1) by M. Rameshni; as known as SMAX and SMAXB the zero SO2 emission is achieved by using the caustic scrubber system after the incineration where the caustic section is replaced by the SETR innovative process.

FIG. 4 consists of 4-4a, 1-1b, and 1-1c, where illustrates diagram of an alternate embodiment of the present disclosure illustrates the scheme from the patent pending of the application filed regard to SUPERSULF process (application Ser. No. 14/826,198, Aug. 14, 2015) the zero SO2 emission is achieved by using the caustic scrubber system after the incineration where the caustic section is replaced by the SETR innovative process.

FIG. 5 consists of 1-1a, 5-5a, 1-1b, 1-1c where illustrates diagram of an alternate embodiment of the present disclosure illustrates the feed gas stream to the incinerator comes from the tail gas absorber overhead in the tail gas treating system.

FIG. 6 consists of 6-6a, 6-6b, 1-1b and 1-1c where illustrates diagram of an alternate embodiment of the present disclosure illustrates the feed gas stream to the incinerator comes from the special design of the SRU and tail gas absorber as known as RICH-SMAX where the tail gas absorber performs as the partial acid gas enrichment and the tail gas recycle is routed to the second zone of the reactor furnace.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or the scope of the inventive concepts or the appended claims in any manner. Rather, the figures and detailed written descriptions are provided to illustrate the inventive concepts to a person of ordinary skill in the art and enable such person to make and use the inventive concepts.

### DETAILED DESCRIPTION OF THE INVENTION

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government related and other constraints, which vary by implementation and from time to time. While a developer's efforts might be complex and time-consuming, such efforts would be, nevertheless, a routine undertaking for those of ordinary skill the art having benefit of this disclosure.

In general terms, Applicant has created new processes for the conversion of sulfur compounds to elemental sulfur using SETR reactors replaces the tail gas treating unit with less equipment while achieving 100% recovery without any waste stream or chemicals.

The present invention relates to processes for recovering sulfur for onshore and offshore applications; refineries, gas plants, IGCC, gasification, coke oven gas, mining and minerals sour gas field developments and flue gas desulfurization onshore and offshore wherein sulfur recovery unit is required for new units or revamps.

In accordance to aspects of this invention; the SETR reactor operates as the adsorbent and regenerator where the cycles are (cold, hot) and (hot, cold) to achieve higher recovery. In addition, the combination of adsorbent and regenerator operation are controlled by using 2-way or 3-way switching valves.

In accordance with aspects of the present invention, it is an object of the present disclosure to provide a process for producing elemental sulfur economically acceptable for, present day industrial operations and higher safety standard.

Another object is to provide such a process which can tolerate variances in operating conditions within a given range without major equipment adaptations. A further object is to provide a process which can be utilized in co-acting phases to provide, at acceptable economics, the capacity required in present-day industrial operations, easy to operate and more reliable and robust operation.

In the discussion of the Figures, the same or similar numbers will be used throughout to refer to the same or similar components. Not all valves and the like necessary for the performance of the process have been shown in the interest of conciseness. Additionally, it will be recognized that alternative methods of temperature control, heating and cooling of the process streams are known to those of skill in the art, and may be employed in the processes of the present invention, without deviating from the disclosed inventions.

In the reaction furnace, the hydrocarbon containing gas stream comprises one or more hydrocarbons selected from the group consisting of alkanes, alkenes, alkynes, cycloalkanes, aromatic hydrocarbons, and mixtures thereof.

The figures illustrate steam reheaters that heats up the gas by using steam, however, any suitable heat exchanger, using different heating media, or fired reheaters using natural gas or acid gas, and hot gas bypass maybe employed in this service.

The figure illustrates a waste heat boiler that produces steam, however, any suitable heat exchanger, such as a water heater, steam superheater or feed effluent exchanger may be employed in this service.

The reaction furnace is equipped with one or more checker wall or choke ring or vector wall to create the turbulent velocity of gas for a better mixing and to prevent cold spot and condensation. In addition the checker wall near the tube sheet of the waste heat boiler to protect the tube sheet from the heat radiation from the burner.

In accordance to this invention; the rate of the air, enriched air or oxygen enrichment stream is adjusted such that the mole ratio of hydrogen sulfide to sulfur dioxide in the gaseous-mixture reaction stream ranges from 1.5:1 to 10:1.

The innovative SETR process comprises at least one Claus catalyst, consisting of alumina, promoted alumina, and titania, but not limited to Iron with Zinc, Iron with Nickel, Cr, Mo, Mn, Co, Mg with promoter on Alumina and with any other combination or any other catalyst systems which are employed in the Claus process.

The converters in the Claus conversion step of this present process disclosure, employ one or more Claus catalysts including alumina catalysts, activated alumina catalysts, alumina/titania catalysts, and/or titania catalysts, Iron with Zinc, Iron with Nickel, Cr, Mo, Mn, Co, Mg with promoter on Alumina and with any other combination or any other catalyst systems which are employed in the Claus process, the catalysts having a range of surface area, pore volume, shapes (e.g., star shaped, beads, or powders), and percent catalyst content (in non-limiting example, from about 50 wt. % to about 95 wt. % Al2O3, having a purity up to about 99+%), without any limitations. The Claus processes within converter and subsequent converters, such as converter may be carried out at conventional reaction temperatures, ranging from about 200° C. to about 1300° C., and more preferably from about 240° C. to about 600° C., as well as over temperature ranges between these ranges, including from about 210° C. to about 480° C., and from about 950° C. to about 1250° C., without limitation.

The number of Claus conversion steps employed, which may range from one stage to more than ten, depends on the particular application and the amount of sulfur recovery required or desired. In accordance with certain non-limiting aspects of the present disclosure, the number and placement of multiple converters/reactors, and the associated condenser systems, may be adjusted without affecting the overall thermal reduction process described herein.

The process is typically able to achieve an overall sulfur recovery efficiency of greater than about 99.8%, and preferably greater than 99.99%, based on the theoretical amount of recoverable sulfur.

With continued reference to the invention, the tail gas stream upon exiting the last reaction stage may optionally be conveyed to any typical tail gas absorption process, BSR, SCOTT, ARCO, and RICH-SMAX or similar and any type of incineration process to increase sulfur recovery efficiency to about 100%.

Accordance to the present invention the detailed description of the figures are in 4 steps: Step 1—Conventional Claus thermal stage with high intensity burner; step 2—at least two Claus catalyst containing alumina titanium catalyst to hydrolyze COS and CS2 from the reaction furnace and to perform Claus reaction; step 3—tail gas SETR reactors consisting of adsorption and regeneration mode of operation coordinated by 2 way or 3 way switching valves located on the tail gas feed, slip of air, slip of amine acid gas and the flue gas of each SETR reactor.

The last condenser is at least one heat exchanger or multiple heat exchangers, dual condensers or combination of water coolers and air coolers to achieve maximum sulfur condensation and sulfur recoveries.

The recovering process from catalytic zones of the catalytic stages comprises cooling the product gas stream in one or more sulfur condensers to condense and recover elemental sulfur from the product gas stream.

In the reaction furnace, the hydrocarbon containing gas stream comprises one or more hydrocarbons selected from the group consisting of alkanes, alkenes, alkynes, cycloalkanes, aromatic hydrocarbons, and mixtures thereof.

The new invention comprises that the SETR reactor operates as an adsorbent process and the mode of operation are cold and hot and switches to hot and cold by switching valves.

The new invention comprises that the sulfur recovery of up to 99.99% or less than 10 ppmv of SO2 in the stack is achieved.

All the heat exchangers defined in this process can be of any type of commercial exchangers such as but not limited to fired heaters, shell and tube, plate and frame, air cooler, water cooler, boiler type, or any suitable exchangers.

All required control systems in the sulfur recovery tail gas treating and incineration are defined based on the latest commercial control systems including but not limited to local panel, DCS control room, burner management systems in the sulfur plant, switching valves sequencer control systems, reactors, condensers, columns incineration and all necessary equipment in this innovation.

The sequence runs fully automatically without requiring any operator action. With the switch-over procedure finished, the zones changed their positions in the process and a new cycle starts.

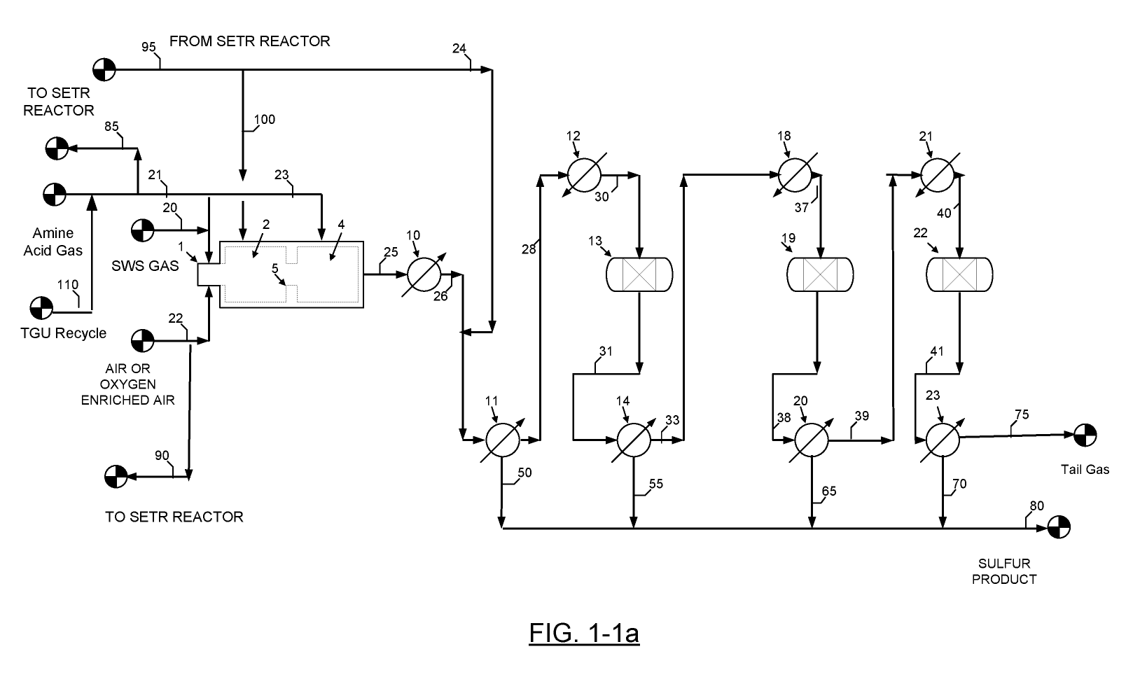

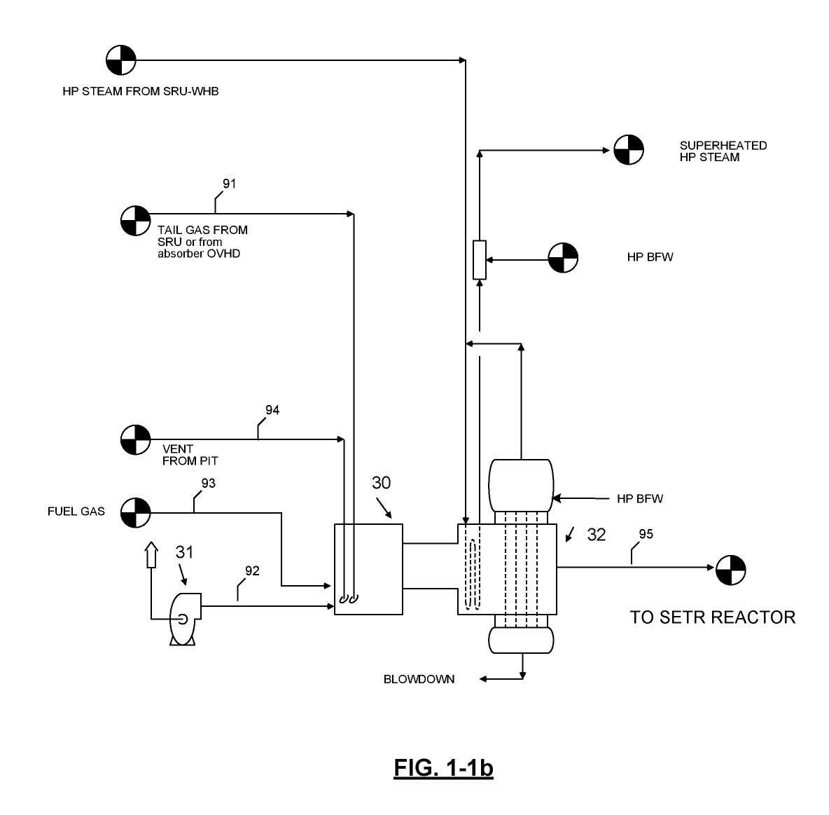

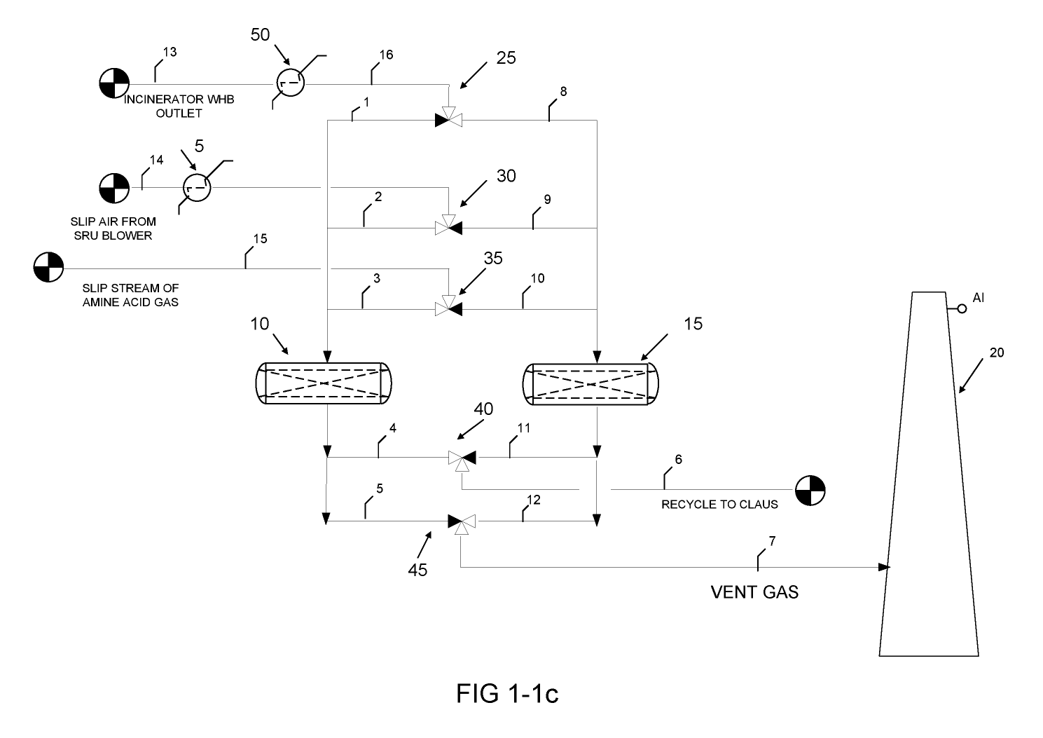

Turning now to the FIG. 1 consists of the FIG. 1-1a, 1-1b and 1-1c. in the FIG. 1-1a, in the reaction furnace (1) the acid gas streams, streams 20, 21 are partially oxidized with air, enriched air or oxygen, stream 22 in the reaction furnace combustion chamber zones; (no. 2 and no. 4) according to the basic chemistry of the Claus process. The acid gas stream is split into two streams where stream 21 is combined with the ammonia acid gas and the remaining of the amine acid gas stream 23 flows to the second zone of the reaction furnace (4) to provide enough flexibility to the operators by adjusting the split flow to achieve the required combustion temperature for destruction of ammonia and hydrocarbons. The choke ring or checker wall or vector wall located inside of the reaction furnace is shown (5). The sulfur is formed as a vapor, and other forms of elemental sulfur are formed in the gas. Combustibles in the gas will burn along with the H2S, and sulfur compounds are formed with their combustion products. Also, H2S will dissociate at high temperature forming hydrogen and elemental sulfur. The regenerator gas recycle from the SETR tail gas unit (95) is added to the reaction furnace stream (100) or it is added to the outlet of the waste heat boiler stream (24). The location of the SETR recycle gas depends on the feed compositions that come from the SETR regeneration reactor and the necessary adequate temperature to process the gas.

In accordance to the invention SETR reactor, a slip stream of the amine acid gas stream (85) and a slip stream of the air or air enriched stream (90) is sent to SETR tail gas unit regeneration reactor to recover the sulfur compounds and recycled back to the Claus unit. Adding H2S will promote the Claus reaction where oxygen is present from the air stream.

Sulfur is formed thermally in the reaction furnace and the products from the exothermic reactions stream 25 are cooled in the Waste Heat Boiler (10) by generating high or medium pressure steam and then stream 26 further cooled in the No. 1 condenser (11) which generates low pressure steam.

The reaction furnace consists of a refractory checker wall near to the waste heat boiler to protect the tube sheet of the waste heat boiler from the heat radiation from the burner.

In the No. 1 Condenser (11) the liquid sulfur is separated and flows to the sulfur pit as stream (50) and the gas stream (28) flows to the No. 1 Claus repeater (12) prior entering to the No. 1 Claus reactor (13), with inlet stream of 30 and the outlet stream of 31.

The outlet of the first Claus reactor stream 31 flows to the No. 2 condenser (14) where the outlet stream of liquid sulfur (55) flows the sulfur pit and the cooled gas stream (33) flows to the No.2 Claus reheater (18) prior entering the No. 2 Claus reactor (19) with the inlet stream of (37) and the outlet stream of (38).

The outlet of the second Claus reactor stream (38) flows to the No. 3 condenser (20) where the outlet stream of liquid sulfur (65) flows the sulfur pit and the cooled gas stream (39) flows to the No.3 Claus reheater (20) prior entering the No. 3 Claus reactor (22) with the inlet stream of (40) and the outlet stream of (41).

The outlet of the third Claus reactor stream (41) flows to the No. 4 condenser (23) where the outlet stream of liquid sulfur (70) flows to the sulfur pit and the cooled gas stream (75) tail gas stream flows to the incineration.

The outlet gas from the No. 1 condenser (11) stream 28 is heated indirectly in the No. 1 reheater (12) by high pressure steam and then stream 30 enters the No. 1 converter (13) which the converter contains mostly Titanium catalyst to hydrolyze the COS and CS2 formed from the thermal section of this invention (1) plus contains Claus catalyst types such as alumina and promoted alumina catalyst to perform the Claus reaction; as the results Sulfur is formed by an exothermic reaction, which creates a temperature rise across the catalyst bed.

In the FIG. 1-1b, the incineration section the feed stream SRU tail gas stream (91) and the pit vent from the sulfur pit degassing vent stream (94) plus the fuel gas stream (93) flows to the incineration.

The incineration consists of a forced draft incinerator (30) and the air blower (31) and with the heat recovery (32). When heat is recovered then as part of energy saving, the additional steam is exported to the facility utility header. The combusted gas from the incinerator (30) is routed to the SETR tail gas treating reactor through the waste heat boiler (32).

In the FIG. 1-1c is shown SETR-SUPER ENHANCED TAIL GAS RECOVERY; A TAIL GAS PROCESS WITH ADSORBENT REACTORS and illustrates the heart of this invention by receiving the gas stream from the incineration system through a waste heat boiler or cooler where the combusted gas stream consisting the sulfur compounds in the form of SO2 (13) cools off further by the cooler (50) and stream (16) enters the SETR adsorbent reactor (10) where it operates at 125 C to 130 C to maximize the SO2 adsorption. In practice lower temperature will increase the adsorption capacity of SO2 but it is important to avoid the water dew point. In addition since the rate of the SO2 adsorption is limited larger residence time than Claus reactor may be needed.

The SETR reactors contain titanium catalyst as the top bed due to oxygen presence from the incinerator and alumina at the bottom where these catalysts have important role during the regeneration process. The adsorbent must be able to tolerate some oxygen and must also have capability to promote the Claus reaction in the regeneration mode therefore, titanium catalyst shall be provided in these SETR reactors.

Turning to FIG. 1-1C, the slip stream of the amine acid gas (15) and slip stream of air stream (14) from the combustion air blower flows to the SETR reactors during the regeneration mode establishing a Claus reaction and higher temperature due to exothermic reaction and the adsorbed SO2 will be regenerated faster. The SETR regeneration reactor operates at 320 C to 400 C to maximize the SO2 regeneration to promote the Claus reaction.

According to this innovation scheme, the regeneration procedure accomplishes a number of chemical transformations. Most importantly, SO2 is displaced by the hot gas and sulphate and thiosulphate which they are present on the surface of the adsorbent and after an uptake cycle are reduced by H2S in the regeneration stream of the amine acid gas, in addition any oxygen which is adsorbed in the uptake cycle will be removed by reaction with H2S.

The combusted gas from the incineration contains SO2, N2, CO2, H2S where will be adsorbed by the catalytic bed in form of O2, SO2, S2O3⁻ and SO4⁻. During the regeneration SO2 and S2O3⁻ are desorbed and H2S and air is added the reactions are resulted in the Claus Equilibrium for the system.

H2S+3/2 O2→H2O+SO2

SO2+2H2S→2H2O+3S

SO4⁻/S2O3⁻+H2S→H2O, S, SO2, H2S

The SETR innovative process is not a sub dew point process where the bed become saturated with sulfur, instead, the SETR process are fixed bed reactors that requires heat up and cool down for the SO2 adsorption-based Claus tail gas process.

The slip stream of the amine acid gas and the air from the combustion air blower will provide the adequate pressure or driving force to recycle the regenerated gas to the Claus unit. The recycle is added to the reaction furnace or to the outlet of the waste heat boiler.

During the adsorption mode of operation the outlet from the adsorbent reactor (7) flows to the stack (20) which is sulfur free. During the regeneration mode of operation the outlet from the regeneration reactor (6) flows back to the Claus unit.

The cold and hot are the two mode of operation where the two SETR reactors switch by using the switching valves automated control system. The switching valves are 2-way or 3way valves steam jacketed to prevent any plugging. FIG. 1-1c represents 5 switching valves as the 3-way switching valves (25, 30, 35, 40 and 45) located on 5 major lines “to and from” SETR reactors.

According to the new innovation SETR process the reactors are switching between 2 mode of operation cold and hot, where each cycle take around 24 hours.

The switching valves are located on (1) combusted gas from the incinerator to the cold bed adsorbent stream (1 and 8), (2) air stream to hot bed regeneration stream (2 and 9), (3) amine acid gas to hot bed regeneration stream (3 and 10), (4) the outlet gas from the hot bed regeneration stream that is recycled back to the Claus unit stream 6 from (4 and 11), (5) the outlet gas from the cold bed adsorbent gas stream to the stack stream 7 from (5 and 12).

The incinerator stack (20) receives the gas stream from the cold bed which is sulfur free, and the stack is equipped with the necessary analyzer monitoring system.

In order to achieve the maximum adsorption and regeneration the streams 13, 14 and 15 temperatures are controlled by adding the proper cooling or heating exchangers.

The SETR tail gas treating system replaces any type of Caustic scrubber system such as DYNAWAVE or any similar system.

The SETR process is cost competitive solutions and do need any chemicals, and not generate any waste stream, where the caustic scrubber system requires caustic as the chemical agent and spent caustic as the waste stream requires additional treatment to prevent any environmental issues.

The innovative SETR reactors contain components like SO2,S2O3⁻ and SO4⁻ during the cold mode of operation, as the results the proper materials is chosen to prevent any corrosion.

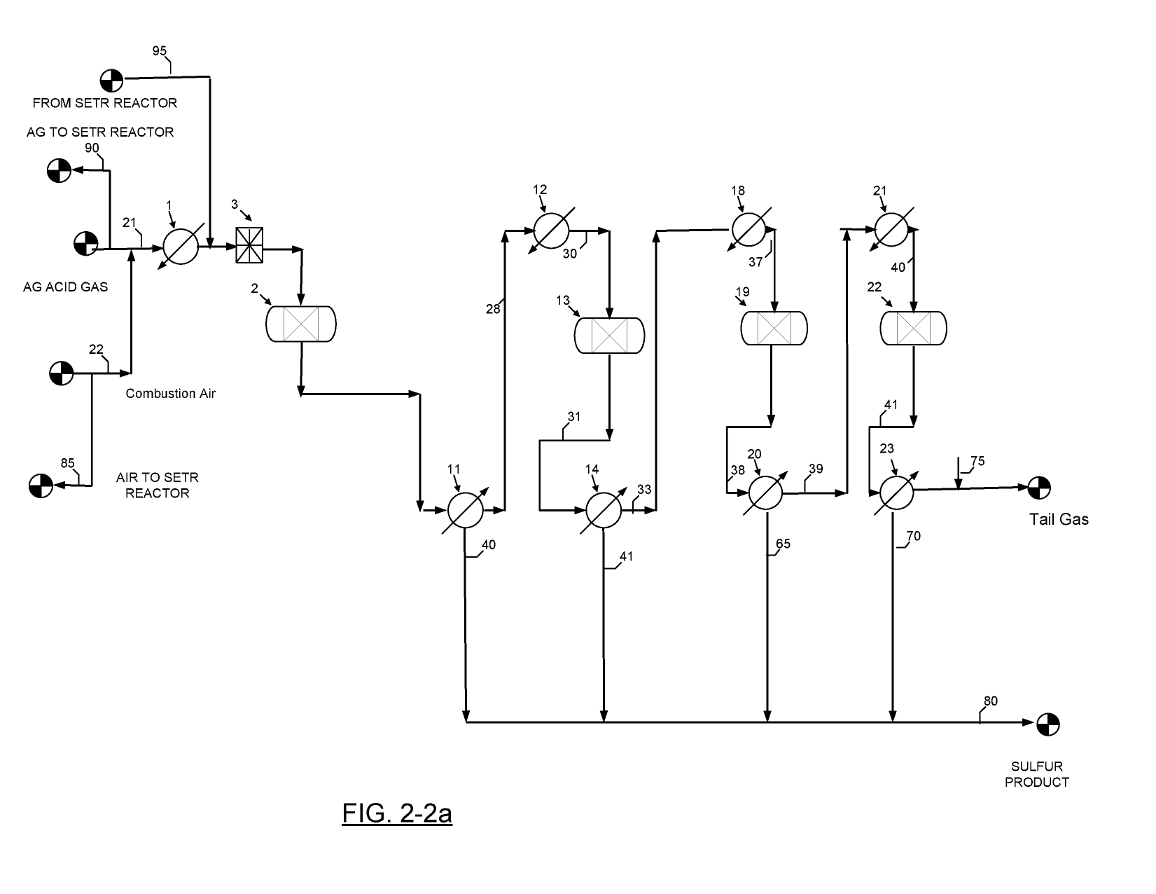

Turing to the FIG. 2 consists of the FIG. 2-2a, 1-1b and 1-1c, where the FIG. 2-2a is the same as FIG. 1-1aexcept the burner and reaction furnace is replaced by a catalytic direct oxidation where applies for the lean acid gas application. Acid gas flows to the repeater (1) then through the mixer (3) flows to a direct oxidation reactor (2) where air is added to the reactor to establish the Claus reaction. The remaining description and the scheme is the same as FIG. 1-1a and the tail gas stream flows to the incineration system FIG. 1-1b and then flows to SETR tail gas treating unit FIG. 1-1c. The direct oxidation catalyst types are Selectox, Titanium, or any direct oxidation catalyst suitable for this process.

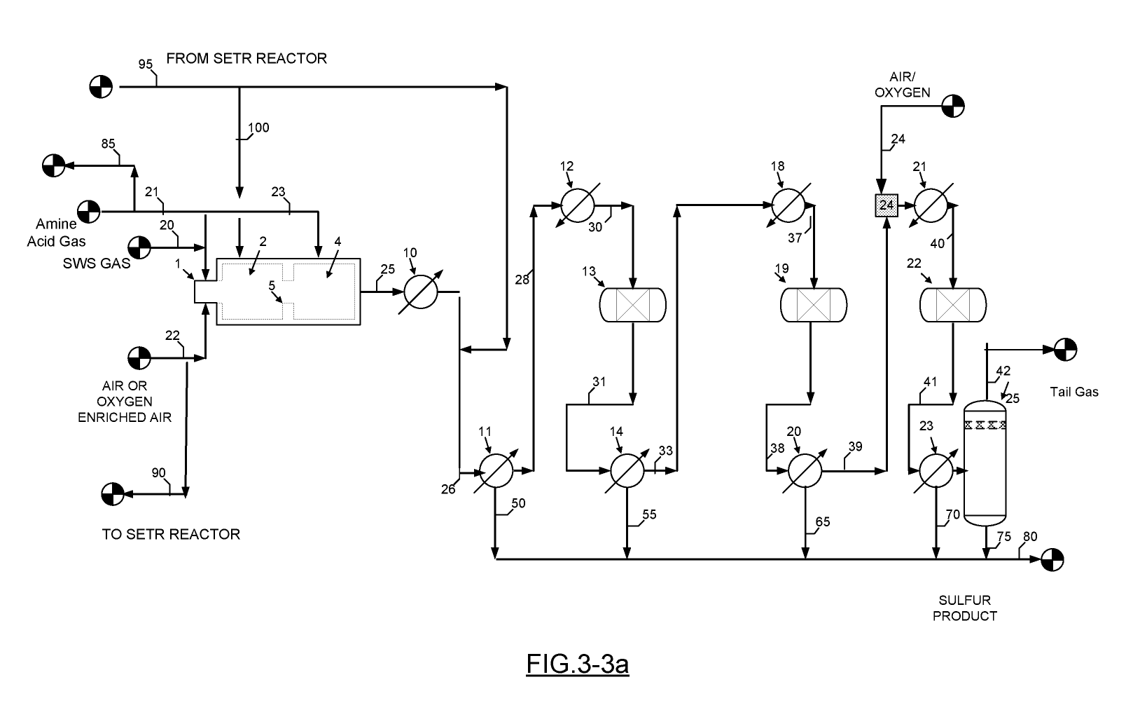

Turning to the FIG. 3 consists of the FIG. 3-3a, 1-1b and 1-1c, where the FIG. 3-3a illustrates the scheme from the patented process, May 5, 2015 (U.S. Pat. No. 9,023,309 B1) by M. Rameshni; the zero emission is achieved by using the caustic scrubber system after the incineration where the caustic section is replaced by the SETR tail gas treating innovative process according to this invention.

In the patented process, May 5,2015 (U.S. Pat. No. 9,023,309 B1) by M. Rameshni, as known as SMAX and SMAXB the catalytic stages consist of the Claus stage one or two, the direct reduction stage and the direct oxidation stage where can achieve up to 99.5% sulfur recovery. The condensed sulfur is separated from the gas in a coalescer section that is integral within each condenser and fitted with a stainless steel wire mesh pad to minimize sulfur entrainment. The tail gas flows to the incineration system the FIG. 1-1b to convert all the sulfur components to SO2. The combusted product are cooled and flows to the SETR tail gas treating process which is illustrated as a new innovative process and it is shown as the FIG. 1-1C where the overall sulfur recovery of near 100% is achieved.

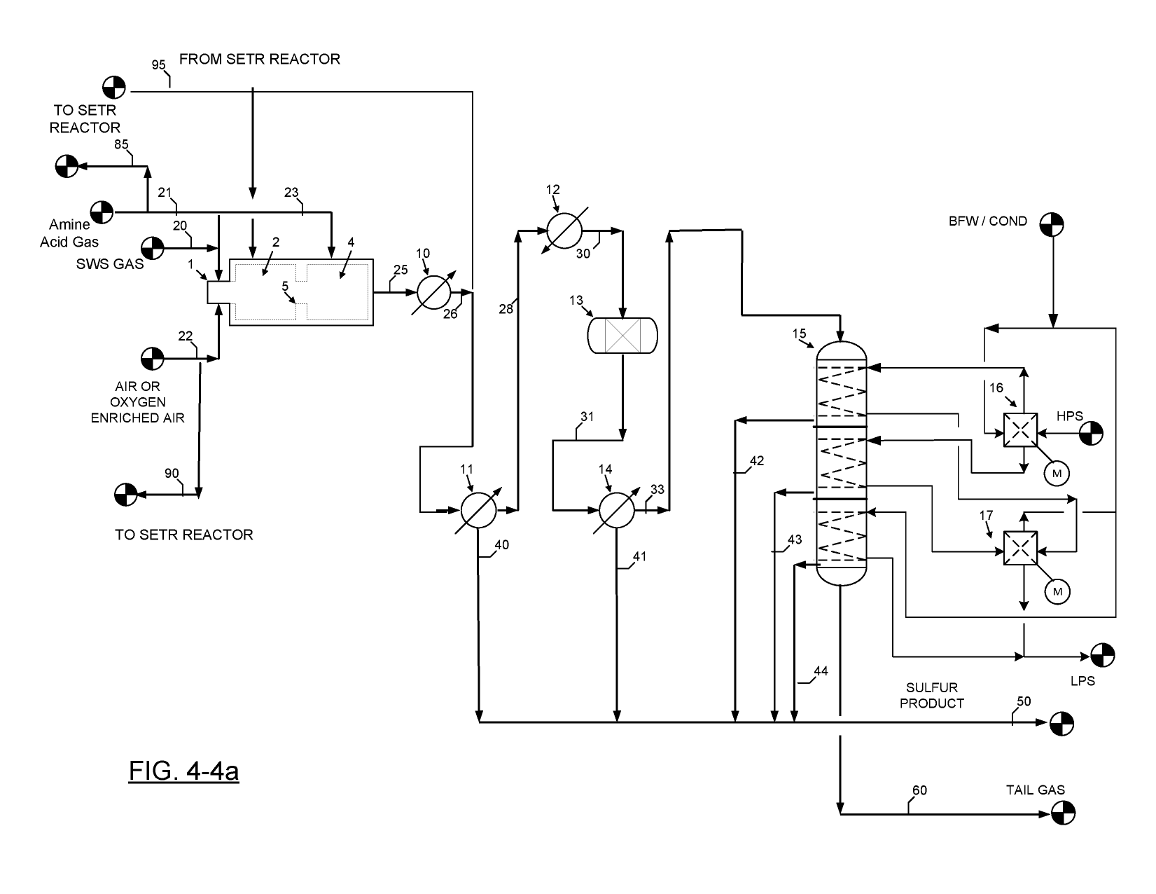

Turning to FIG. 4 consists of 4-4a, 1-1b, and 1-1c, where illustrates diagram of an alternate embodiment of the present disclosure illustrates the scheme from the patent pending of the application filed regard to SUPERSULF process (application Ser. No. 14/826,198, Aug. 14, 2015) the zero emission is achieved by using the caustic scrubber system after the incineration where the caustic section is replaced by the SETR innovative process.

In the patent pending process SuperSulf, (application Ser. No. 14/826,198, Aug. 14, 2015) consists of the sub dew point process with internal heating and cooling reactors and the switching valves are located on the utilities line. The process includes the tail gas treating with the amine section to achieve 99.9% sulfur recovery and with the Caustic zero emission is achieved. According to FIG. 4-4a in the sulfur recovery section of this application up to 99.5% sulfur recovery can be achieved. The tail gas stream from the last condenser flows to the incineration system the FIG. 1-1b to convert all the sulfur components to SO2. The combusted product are cooled and flows to the SETR tail gas treating process which is illustrated as a new innovative process and it is shown as the FIG. 1-1C where the overall sulfur recovery of near 100% is achieved. For large capacity sulfur plant the tail gas unit in this application can be kept and the SETR tail gas can be added after the incineration before the stack where the SETR reactors will be smaller due to processing less SO2.

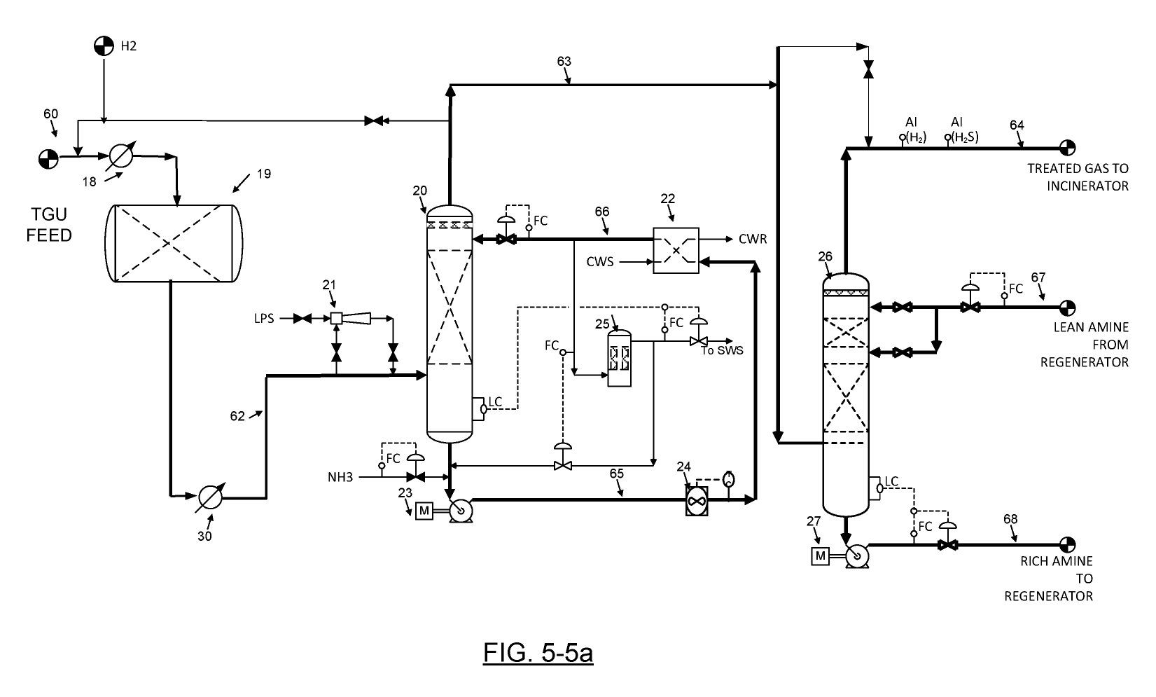

Turning to FIG. 5 consists of FIG. 1-1a, 5-5a, 1-1b, and 1-1c where illustrates diagram of an alternate embodiment of the present disclosure illustrates the feed gas stream to the incinerator comes from the tail gas absorber overhead in the tail gas treating system. FIG. 5-5a represents a conventional tail gas treating including the hydrogenation reactor, quench system and the amine unit such as BSR, SCOTT, ARCO, RICH-SMAX and any similar scheme such as the tail gas scheme in the patent pending process SuperSulf, (application Ser. No. 14/826,198, Aug. 14, 2015. In FIG. 5, the scheme of the 1-1a, 1-1b and 1-1c is the same as FIG. 1 as described except in the FIG. 1a the acid gas stream recycle from the regeneration stream 110 from the amine regeneration overhead is added. If the sulfur plant includes the conventional tail gas treating with the amine section as shown on the FIG. 5-5a is a conventional tail gas treating where it receives the tail gas stream from the FIG la for further processing to increase more recovery of H2S and the tail gas absorber overhead flows to the incineration into the FIG. 1b and finally the combusted gas flows to the FIG. 1C SETR reactors which is the current innovative process and it is already described under FIG. 1.

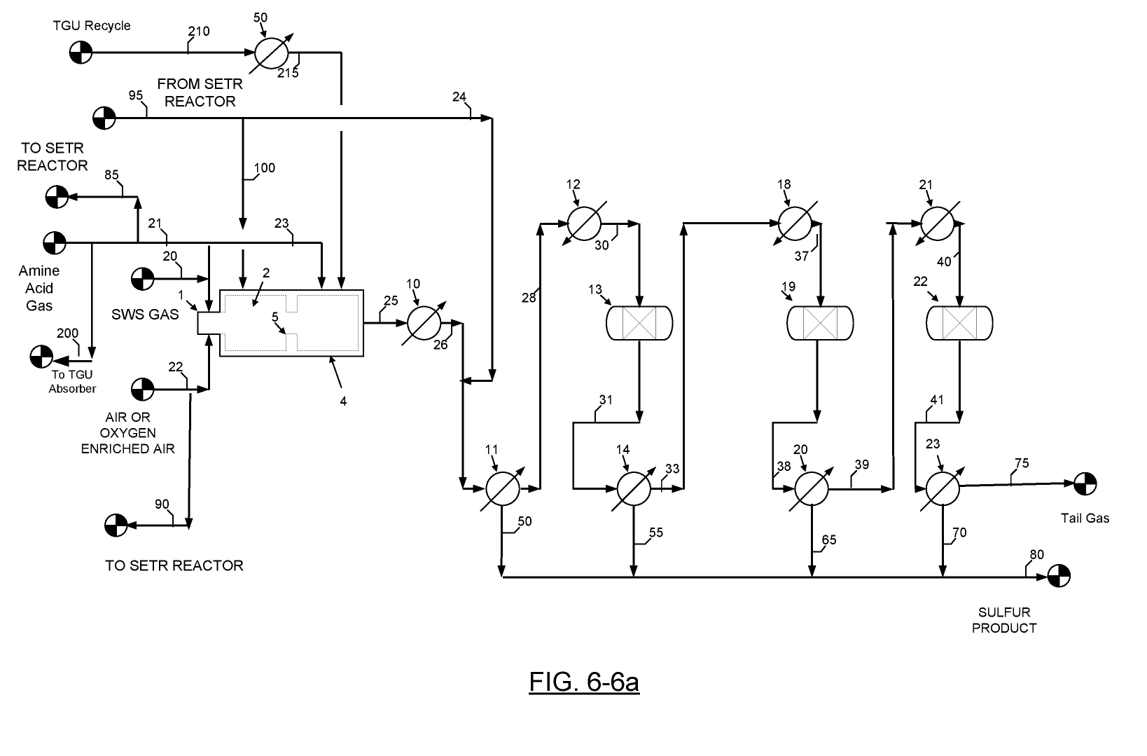

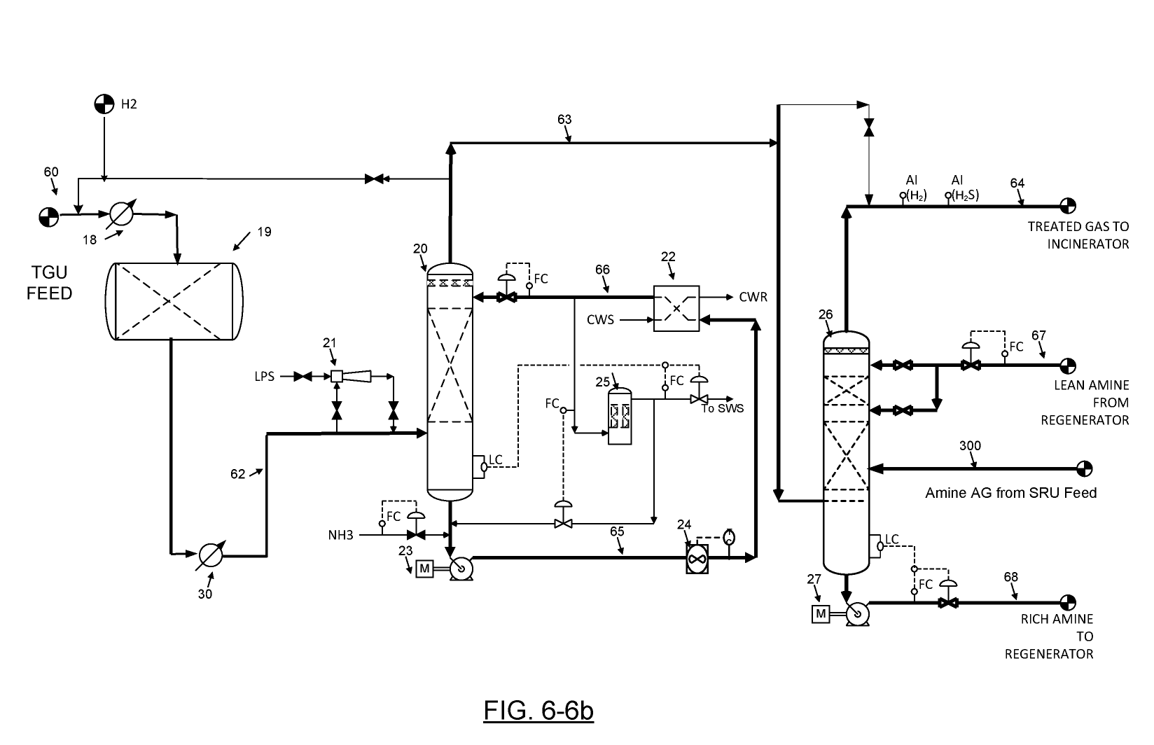

Turing to the FIG. 6 that consists of FIG. 6-6a, 6-6b, 1-1b and 1-1c where illustrates diagram of an alternate embodiment of the present disclosure illustrates the feed gas stream to the incinerator comes from the special design of the SRU and tail gas absorber as known as RICH-SMAX where the tail gas absorber performs as the partial acid gas enrichment and the tail gas recycle is routed to the second zone of the reactor furnace.

The acid gas is split the acid gas from the amine unit where up to 75% of the amine gas entered the first zone of the reaction furnace and the SETR reactors and up to 25% of the acid gas is routed to the tail gas absorber stream (200) in addition to the quench overhead that flows to the tail gas absorber. The tail gas amine unit is designed with the much higher amine loading similar to the amine unit, so in Summary the FIG. 6-6a and 6-6b are similar to FIG. 1-1a and FIG. 5-5a accordingly except as noted.

(a) 25% of the amine acid gas is sent to the tail gas absorber known as RICH-SMAX Absorber stream 200 on FIG. 6-6a and shown on FIG. 6-6b as acid gas stream (300) from the SRU;
(b) The tail gas absorber overhead stream 64 flows to the incineration and then flows to SETR reactors;
(c) Up to 75% of the amine acid gas is sent to the FIRST ZONE OF THE REACTION FURNACE and the SETR reactors;
(d) The tail gas absorber operates at higher rich loading (0.2-0.3 mol/mol);
(e) The tail gas recycle from the tail gas regeneration unit is recycled to the SRU but not to the first zone, as stream (210) instead:
The acid gas from the tail gas regeneration column, which is hydrocarbon/mercaptan free, is recycled back to the SRU. It is preheated and flows to the second zone of the reaction furnace. The combusted gas from the zone 1 reaction furnace flows to the second zone through choke ring where the temperature is above ignition temperature, and burn the acid gas in the second zone and the combusted;
(f) The tail gas absorber shall be designed with 0.2 to 0.3 mol/mol loading. The acid gas loading in the tail gas absorber is normally 0.1 mol/mol maximum, and the acid gas loading for the amine absorber is normally 0.3 mol/mol, it means there is significant free amine in the tail gas absorber to process the portion of the acid gas. The tail gas absorber acts not only as a tail gas absorber but also as an enriched absorber without adding significant cost to the project. This scheme also removes the hydrocarbons/mercaptans, which cause problems in the second zone of the reaction furnace. As H2S concentration increases the 25% slipstream from the SRU feed to the tail gas absorber may be reduced as long the combustion temperature of 1100 C-1150° C. in the first zone of the reaction furnace is achieved.

The FIG. 1-1b and 1-1c will remain the same where the RICH-SMAX tail gas absorber overhead flows to the incineration system and the cooled combusted gas flows to the SETR reactors FIG. 1-1c and the same operation take place to achieve near zero emission.

In summary, the SETR innovative process is a tail gas treating system that can be added after the incineration to any type of sulfur recovery and the tail gas treating technology from the conventional Claus ranging up to 98% sulfur recovery, to any sub dew point processes like CBA, MCRC, Smartsulf, Sulfreen, and SuperSulf or similar ranging up to 99.9% sulfur recovery, to any direct reduction and direct oxidation, like SuperClaus, EuroClaus, SMAX, and SMXB or similar ranging up to 99.9% sulfur recovery, and to any tail gas treating like BSR, ARCO RICH-SMAX and SCOTT or similar ranging up to 99.9% sulfur recovery, and catalytic incineration or similar which by adding the SETR reactors results free sulfur emission in the stack near to 100% sulfur recovery.

The size of the SETR reactors are based on the SO2 needs to be processed in the adsorbent and regeneration stage and the duration of each cycle is the function of the SO2 adsorbent.

All of the compositions, methods, processes and/or apparatus disclosed and claimed herein can be made and executed without undue experimentation in light of the present disclosure. While the compositions and methods of this invention have been described in terms of preferred embodiments, it will be apparent to those of skill in the art that variations may be applied to the compositions, methods, processes and/or apparatus and in the steps or sequence of steps of the methods described herein without departing from the concept and scope of the invention. Additionally, it will be apparent that certain agents which are both chemically and functionally related may be substituted for the agents described herein while the same or similar results would be achieved. All such similar substitutes or modifications apparent to those skilled in the art are deemed to be within the scope and concept of the invention. The disclosed and undisclosed embodiments are not intended to limit or restrict the scope or applicability of the invention conceived of by the Applicant, but rather, in conformity with the patent laws, Applicants intends to protect all such modifications and improvements to the full extent that such falls within the scope or range of equivalents.

We claim:

1. A tail gas treating process for recovering the sulfur compounds and recycling back to the sulfur recovery plant located after the tail gas incineration and before the stack, it is not a sub dew point process where the bed become saturated with sulfur, instead, the SETR process are fixed bed reactors that requires heat up and cool down for the SO2 adsorption-based Claus tail gas process; The SETR reactors do not use any chemical agent or solvent and do not produce any chemical or spent waste stream. The process comprising the following 7 steps:
A-step 1) The process comprises two reactors as the adsorbent and regeneration reactors operates in two cycles cold and hot mode;
B-step 2) The process comprises at least the Claus catalysts containing Alumina and Titanium catalysts to initiate and to perform the Claus reaction in regeneration mode;
C-step 3) The adsorbent cold reactor receives the incineration outlet combusted gas stream through a cooler to adsorb sulfur compounds as SO2,
D-step 4) The regeneration hot reactor receives a slip stream of amine acid gas feed stream to the SRU and a slip stream of air from the combustion air blower to regenerate adsorbed SO2 and to initiate the Claus reaction, mode of operation switches between hot and cold at least once a day;
E-step 5) The process comprises motor operating switching valves to control these reactors for switching between hot and cold mode of operation on five inlet and outlet streams;
F-step 6) The outlet gas stream from the adsorbent cold reactor flows to the stack as the sulfur free stream and the outlet gas stream from the regeneration hot reactor is recycled back to the sulfur plant;
G-step 7) The process comprises the incineration system replacing any type of the Caustic scrubber system to achieve SO2 emission of less than 50 ppmv, preferably less than 10 ppmv respectively.

2. The process of claim 1, wherein, the acid gas streams consist of at least one member selected from the group consisting of H2S, NH3, HCN, H2, CO, CO2, O2 COS, N2, CS2, hydrocarbons, mercaptans, sulfur vapors and steam water.

3. The process of claim 1, wherein, in any type of the sulfur plants, the SETR tail gas treating can be added after the incineration and before the stack to increase overall recovery and to reduce the SO2 emission, in such the sulfur plants can be the conventional Claus, any sub dew point processes, Claus stage plus direct oxidation and direct reduction stages, the conventional tail gas and amine treating units unit, partial enrichment tail gas treating unit, and for acid gases with low H2S concentration known as lean acid gas where direct oxidation catalyst types Selectox, Titanium or similar are used.

4. The process of claim 1, wherein the step 1 reaction furnace of the sulfur plant is equipped with one or more checker wall or choke ring or VECTORWALL.

5. The process of claim 1, wherein the cold adsorbent reactor operates at 125 C to 130 C to maximize the SO2 adsorption and the SETR regeneration reactor operates at 320 C to 400 C to maximize the SO2 regeneration and to promote the Claus reaction.

6. The process of claim 1, wherein the recycle gas from the SETR tail gas treating is injected to the reaction furnace or downstream of the first condenser.

7. The process of claim 1, wherein, the catalytic stages of the sulfur plants and the SETR reactors consists of one or more Claus catalysts including alumina catalysts, activated alumina catalysts alumina/titania catalysts, and/or titania catalysts, Iron with Zinc, Iron with Nickel, Cr, CO/MO, Mo, Mn, Co, Mg with promoter on Alumina and with any other combination or any other catalyst systems which are employed in the Claus process. The catalysts having a range of surface area, pore volume, shapes. The Claus processes within converter and subsequent converters, such as converter may be carried out at conventional reaction temperatures, ranging from about 200° C. to about 1300° C., and from about 240° C. to about 600° C., as well as over temperature ranges between these ranges, including from about 210° C. to about 480° C., and from about 950° C. to about 1250° C.

8. The process of claim 1, wherein, the SETR reactors consist of Titanium catalyst is located at the top due to oxygen presence and the alumina at the bottom, where the air stream flows to the top of the reactor.

9. The process of claim 1, wherein, the recycle gas from the SETR regeneration reactor has enough driving force or adequate pressure because the slip stream of the amine acid gas and air from the combustion air blower provides sufficient pressure to the recycle the regenerated gas stream.

10. The process of claim 1, wherein, the switching valves are 2-ways, or 3-ways type located at least on 5 streams, 3 inlet gas stream to the reactors and 2 outlet gas stream from the reactors.

11. The process of claim 1, wherein, the tail gas is further processed in the amine tail gas unit to absorb the H2S and in the regeneration section the recovered acid gas is recycled to the sulfur recovery into the reaction furnace, the absorber overhead is routed to the incineration followed by the SETR reactors.

12. The process of claim 1, wherein, the step 5 where the tail gas is sent to the conventional thermal incineration replacing any type of the caustic scrubber with the SETR reactors for achieving SO2 emission of less than 50 ppmv preferably less than 10 ppmv respectively which is equivalent to 99.99+% sulfur recovery.

13. The process of claim 1, wherein, the rate of the air, enriched air or oxygen enrichment stream is adjusted such that the mole ratio of hydrogen sulfide to sulfur dioxide in the gaseous-mixture reaction stream ranges from 1.5:1 to 10:1 in any type of sulfur recovery unit.

14. The process of claim 1, wherein, the last condenser is at least one heat exchanger or multiple heat exchangers, dual condensers or combination of thermoplate, water coolers and air coolers to achieve maximum sulfur condensation and sulfur recoveries.

15. The process of claim 1, wherein, in the reaction furnace, the hydrocarbon containing gas stream comprises one or more hydrocarbons selected from the group consisting of alkanes, alkenes, alkynes, cycloalkanes, aromatic hydrocarbons, and mixtures thereof.

16. The process of claim 1, wherein, the slip stream of the amine acid gas and slip stream of air is adequate to establish the proper reaction temperature and to promote the Claus reaction and to regenerate the maximum adsorbed SO2.

17. The process of claim 1, wherein, the combusted gas from the incineration contains SO2, N2, CO2, H2S where will be adsorbed by the catalytic bed in form of O2, SO2, S2O3− and SO4⁻. During the regeneration SO2 and S2O3⁻ are desorbed and H2S and air is added the reactions are resulted in the Claus Equilibrium for the system.

18. The process of claim 1, wherein, the regeneration procedure accomplishes a number of chemical transformations. Most importantly, SO2 is displaced by the hot gas and sulphate and thiosulphate which they are present on the surface of the adsorbent and after an uptake cycle are reduced by H2S in the regeneration stream of the amine acid gas, in addition any oxygen which is adsorbed in the uptake cycle will be removed by reaction with H2S.

19. The process of claim 1, wherein, the SETR reactors can be added to the scheme of the patented process, May 5, 2015 (U.S. Pat. No. 9,023,309 B1) by M. Rameshni; as known as SMAX and SMAXB to achieve zero SO2 emission.

20. The process of claim 1, wherein, the SETR reactors can be added to the scheme of the patent pending of the application filed regard to SUPERSULF process (application Ser. No. 14/826,198, Aug. 14, 2015) the zero SO2 emission is achieved.
